(19) United States
(12) Patent Application Publication
(10) Pub. No.: US 2006/0117917 A1
(43) Pub. Date: Jun. 8, 2006

(54) Socket having anti-slippage structure for preventing deterioration of a screw head

(76) Inventor: Ying-Mo Lin, Nantou County (TW)

Correspondence Address: CHARLES E. BAXLEY, ESQ., 90 JOHN STREET, THIRD FLOOR, NEW YORK, NY, 10038, US

(21) Appl. No.: 11/131,683

(22) Filed: May 17, 2005

(30) Foreign Application Priority Data
Dec. 7, 2004 (TW) 093219645

(51) Int. Cl. B25B 13/06

(52) U.S. Cl. 81/125; 81/121.1

(57) ABSTRACT

The present invention relates to a socket, at an end of the socket is formed an engaging hole for engaging with a screw head to be operated, and at another end of the socket formed a coupling hole for engaging with a locking portion of a socket wrench, wherein the socket is driven by the socket wrench to rotate the screw head to be operated; and the engaging hole is tapered inward and is defined a plurality of grooves for accommodation of angles of the screw head to be operated, a plurality of stop ribs having a hook-shaped cross section are formed in the engaging hole for abutting against a center portion of each side of the screw head to operated.

### BACKGROUND OF THE INVENTION

1. Field of the Invention

The present invention relates to a socket, and more particularly to a socket having anti-slippage structure for preventing deterioration of a screw head.

2. Description of the Prior Arts

Referring to FIGS. 1 and 2, a conventional socket 10 is always structured in a manner that spaces 13 should be left between the engaging hole 12 of the socket 10 and the screw head 11 in order to permit the screw head 11 pass clearly through. Therefore, when the socket 10 rotates the screw head 11, the rotating force will be focused on the angles of the screw head 11. Since the screw head 11 is a low-value consumption element, and the socket 10 is a necessary tool for rotating the screw head, the hardness of the socket 10 must be much higher than that of the screw head 11. As a result, the angles of the screw head 11 are likely to be deteriorated after a certain time of use, as shown in FIG. 2, afterwards the screw head 11 will be slipped from the socket 10.

The present invention has arisen to mitigate and/or obviate the afore-described disadvantages.

### SUMMARY OF THE INVENTION

The primary objective of the present invention is to provide a socket having anti-slippage structure for preventing deterioration of a screw head, a plurality of stop rib having a hook-shaped cross section are formed in the engaging hole for abutting against a center portion of each side of the screw head to operated. Besides, a plurality of grooves are defined in the engaging hole of the socket for accommodation of angles of the screw head, so that the screw head can be prevented from being deteriorated during rotation.

The secondary objective of the present invention is to provide a socket having anti-slippage structure for preventing deterioration of a screw head, since the respective stop ribs abut against the center portion of the respective sides of the screw head, the rotating force of the socket will be applied to the center portion of the respective sides of the screw head. Therefore, an already deteriorated screw head also can be rotated without slippage.

A socket is provided in accordance with the present invention, at an end of the socket formed an engaging hole for engaging with a screw head to be operated, and at another end of the socket formed a coupling hole for engaging with a locking portion of a socket wrench, wherein the socket is driven by the socket wrench to rotate the screw head to be operated; and the engaging hole is tapered inward and is defined a plurality of grooves for accommodation of angles of the screw head to be operated, a plurality of stop ribs having a hook-shaped cross section are formed in the engaging hole for abutting against a center portion of each side of the screw head to operated.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 shows a conventional socket being used to rotate a screw head;

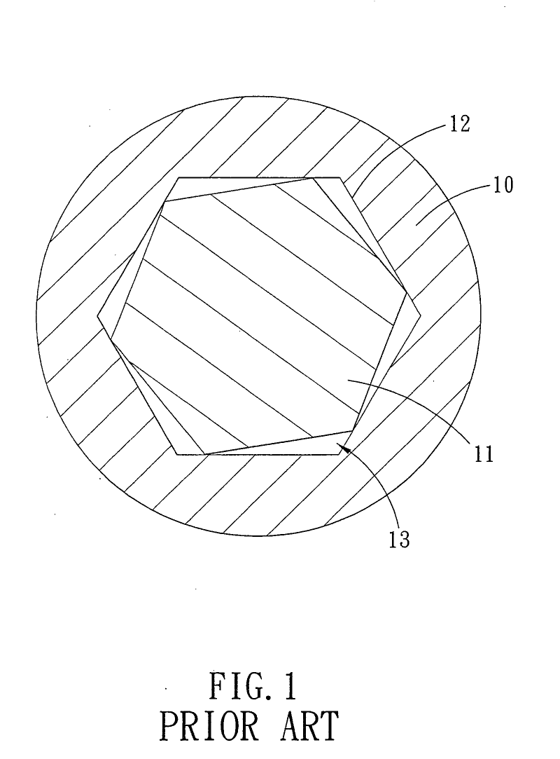

FIG. 2 shows a conventional socket being used to rotate a deteriorated screw head;

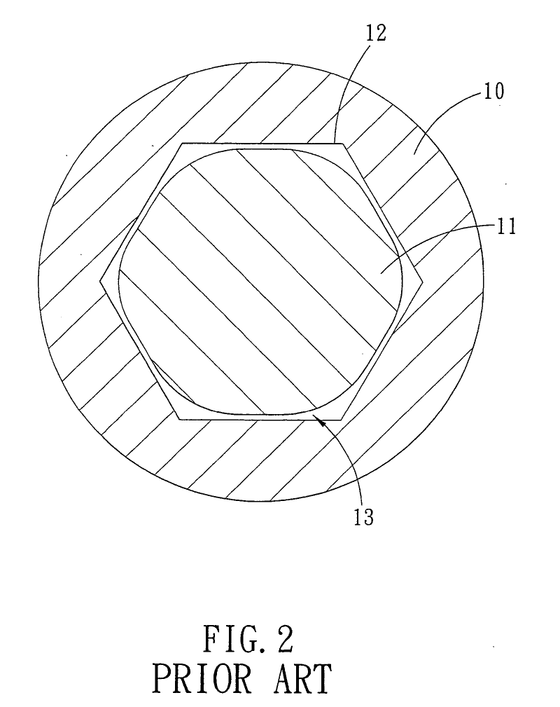

FIG. 3 is a perspective view of a socket in accordance with the present invention;

FIG. 4 is a cross section view along the vertical direction of the socket in accordance with the present invention;

FIG. 5 is a cross section view along the transverse direction of the socket in accordance with the present invention;

FIG. 6 is an operational view of the socket in accordance with the present invention;

FIG. 7 shows the socket in accordance with the present invention being used to rotate a screw head;

FIG. 8 shows the socket in accordance with the present invention being used to rotate a deteriorated screw head.

### DETAILED DESCRIPTION OF THE PREFERRED EMBODIMENT

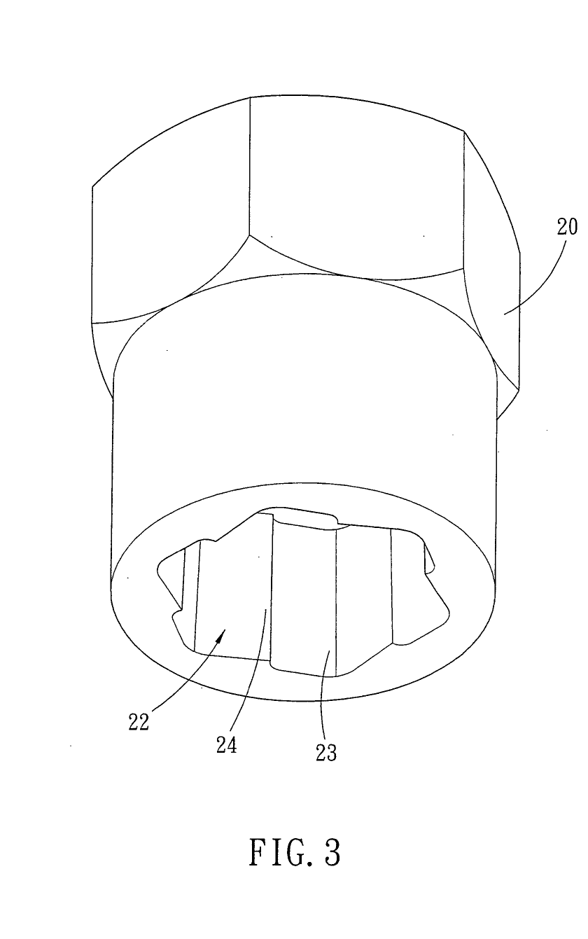

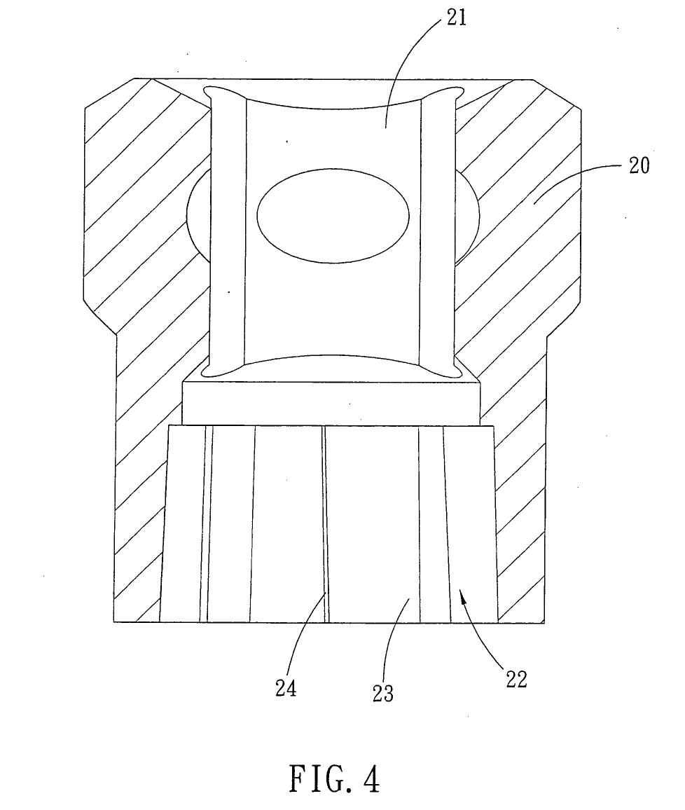

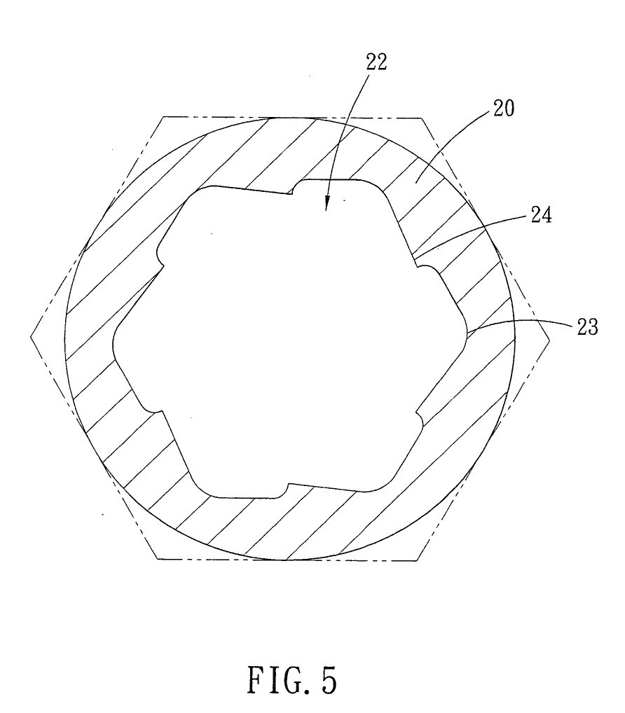

Referring to FIGS. 3-5, a socket 20 in accordance with the present invention is provided at an end thereof with a coupling hole 21 whose cross section is tetragonal, at another end of the socket 20 is formed an engaging hole 22 that is hexagonal in cross section and is tapered inward. At each corner of the engaging hole 22 is defined a groove 23, and close to the center portion of the respective sides of the engaging hole 22 is formed a stop rib 24 whose cross section is hook-shaped.

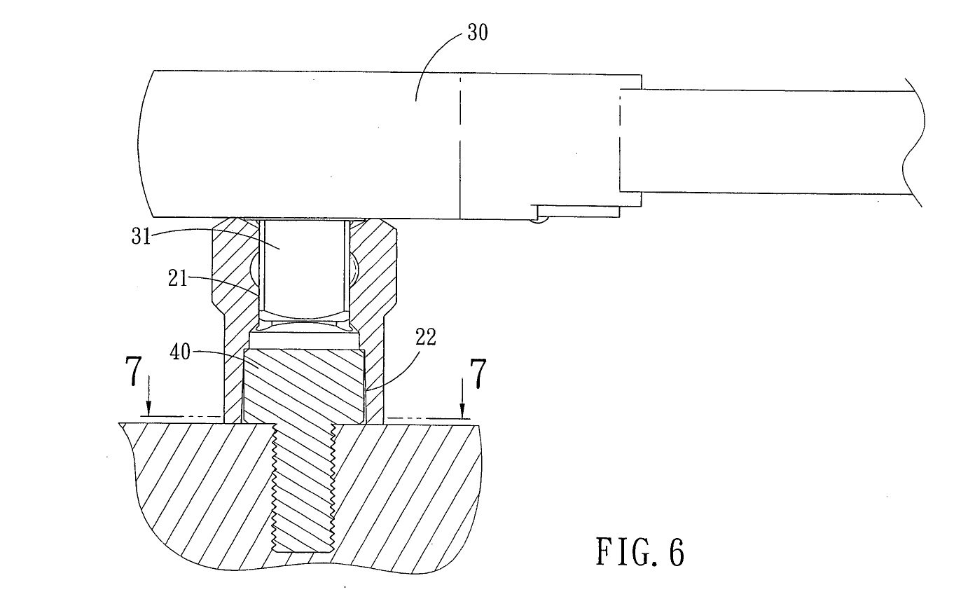

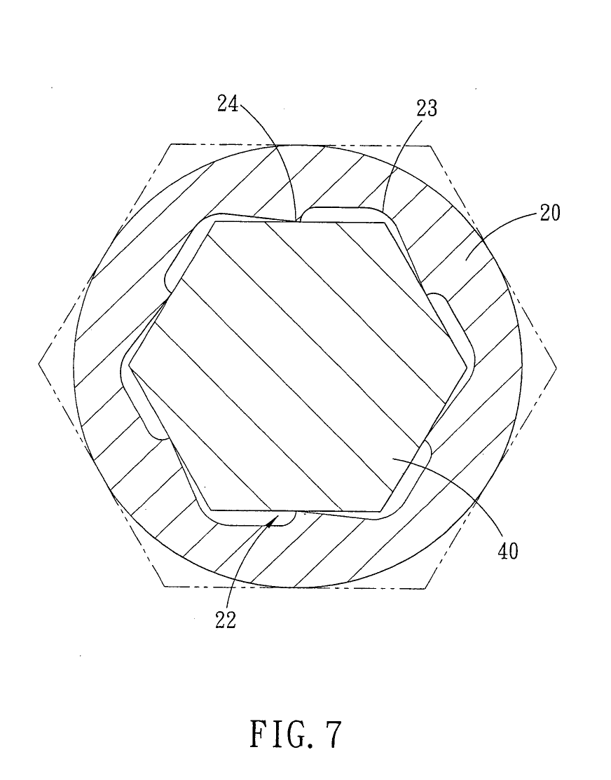

For a better understanding of the present invention, its operation and function, references should be made to FIGS. 6 and 7, a locking portion 31 of a socket wrench 30 is engaged in the coupling hole 21 of the socket 20, while the tapered space of the engaging hole 22 of the socket 20 is provided for engaging with the screw head 40. The taper angle of the engaging hole 22 (the angle between the inner edge and the axial line of the engaging hole 22) is preferably 10 degree at which the screw head 40 can be optimally engaged in the socket, and then the stop ribs 24 will abut against the center portion of the respective sides of the screw head 40, while the respective angles of the screw head 40 can be accommodated in the grooves 23 of the engaging hole 22.

When the user rotates the socket 20 by turning the socket wrench 30, the socket 20 will rotate the screw head 40 synchronously by using the stop ribs 24 to pushing against the center portion of the respective sides of the screw head 40.

Since the respective stop ribs 24 abuts against the center portion of the respective sides of the screw head 40, and the grooves 23 of the engaging hole 22 can provide enough space for the respective angles of the screw head 40, unlike the conventional socket, the rotating force of the socket 20 will not be focused on the angles of the screw head 40, and thus the angles of the screw head 40 can be prevented from being deteriorated during rotation.

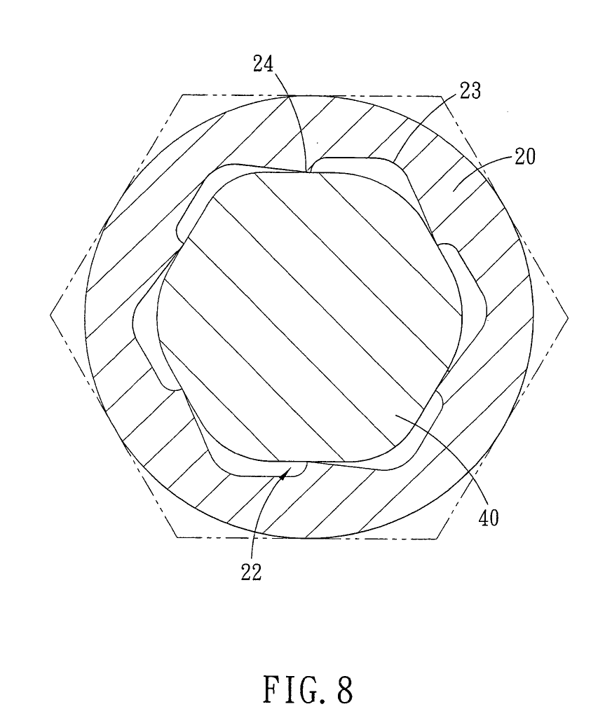

Referring to FIG. 8, the socket 20 of the present invention can also be used to rotate an already deteriorated screw head 40. Since the respective stop ribs 24 abut against the center portion of the respective sides of the screw head 40, the rotating force of the socket 20 will be applied to the center portion of the respective sides of the screw head 40. Therefore, the deteriorated screw head 40 can be rotated without slippage.

While we have shown and described various embodiments in accordance with the present invention, it should be clear to those skilled in the art that further embodiments may be made without departing from the scope of the present invention.

What is claimed is:

1. A socket having anti-slippage structure for preventing deterioration of a screw head, at an end of the socket formed an engaging hole for engaging with a screw head to be operated, and at another end of the socket formed a coupling hole for engaging with a locking portion of a socket wrench, wherein the socket is driven by the socket wrench to rotate the screw head to be operated; and the engaging hole is tapered inward and is defined a plurality of grooves for accommodation of angles of the screw head to be operated, a plurality of stop ribs having a hook-shaped cross section are formed in the engaging hole for abutting against a center portion of each side of the screw head to operated.

2. The socket as claimed in claim 1, wherein a taper angle between inner edge and axial line of the engaging hole is no greater than 10 degree.
